(19) United States
(12) Patent Application Publication
(10) Pub. No.: US 2012/0272822 A1
(43) Pub. Date: Nov. 1, 2012

(54) PROCESS FOR PRESSURE SWING ADSORPTION

(75) Inventor: Paul Alvin Sechrist, South Barrington, IL (US)

(73) Assignee: UOP, LLC, Des Plaines, IL (US)

(21) Appl. No.: 13/098,290

(22) Filed: Apr. 29, 2011

(51) Int. Cl. B01D 53/047

(52) U.S. Cl. 95/106

(57) ABSTRACT

One exemplary embodiment can include a process for pressure swing adsorption. Generally, the process includes passing a fluid through a first channel for adsorbing at least one component while simultaneously passing a stream desorbing a component through a second channel. The first and second channels may be in thermal communication for transferring heat from the first channel undergoing adsorption to the second channel undergoing desorption.

### FIELD OF THE INVENTION

This invention generally relates to a process for pressure swing adsorption.

### DESCRIPTION OF THE RELATED ART

Often, adsorption of a gas onto a solid adsorbent can liberate energy. As a result, the temperature can rise at the adsorption interface. A temperature wave can move through an adsorber as the gas is being adsorbed. Conversely, desorption often consumes energy. As a result, temperature may decrease at the desorption interface. Similarly, this desorption wave can move through the desorber.

The liberation or consumption of heat may adversely affect, respectively, the adsorption or desorption equilibrium. As such, it is desirable to remove the heat of adsorption and provide the heat to desorption by providing, e.g., additional streams for providing or removing heat to an adsorbent. However, these additional streams can increase an adsorber size, require additional equipment, and/or increase operating costs. As a consequence, it would be desirable to minimize the heat transfer within the adsorber to reduce the amount and size of equipment and improve operational efficiency.

### SUMMARY OF THE INVENTION

One exemplary embodiment can include a process for pressure swing adsorption. Generally, the process includes passing a fluid through a first channel for adsorbing at least one component while simultaneously passing a stream desorbing a component through a second channel. The first and second channels may be in thermal communication for transferring heat from the first channel undergoing adsorption to the second channel undergoing desorption.

Another exemplary embodiment may be a process for pressure swing adsorption. The process can include providing an adsorber forming a first channel and a second channel, providing a feed to the first channel, and providing simultaneously a co-current purge stream to the second channel. Typically, a component of the feed is adsorbed, and the component is desorbed. Usually, the heat generated is communicated between the first and second channels.

A further exemplary embodiment can be a process for pressure swing adsorption. The process can include an adsorber forming a plurality of channels at a first elevation and another plurality of channels at a second elevation, passing a feed into the plurality of channels at the first elevation, and passing a purge stream into the another plurality of channels at the second elevation. Usually, a component of the feed is adsorbed, and the component is desorbed. Heat generated from adsorption can be communicated from the plurality of channels to the another plurality of channels undergoing desorption.

In one exemplary embodiment, a barrier can prevent mass transfer while allowing heat transfer between the simultaneous adsorption and desorption of a material, such as a gas. As a result, the heat of adsorption can transfer through the barrier and be utilized on the other side where desorption is occurring. As a result, this efficient utilization of the heat can minimize the use of additional streams required to remove or provide heat to the adsorber. Hence, the adsorber can operate more efficiently.

### DEFINITIONS

As used herein, the term “stream” can include various hydrocarbon molecules, such as straight-chain, branched, or cyclic alkanes, alkenes, alkadienes, and alkynes, and other substances, such as impurities, gases, e.g., hydrogen, sulfur compounds, and nitrogen compounds, and liquids, such as water.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “rich” can mean an amount of at least generally about 50%, and preferably about 70%, by mole, of a compound or class of compounds in a stream.

As used herein, the term “substantially” can mean an amount of at least generally about 80%, preferably about 90%, and optimally about 99%, by mole, of a compound or class of compounds in a stream.

As depicted, process flow lines in the figures can be referred to interchangeably as, e.g., lines, pipes, feeds, fluids, products, or streams.

As used herein, the terms “adsorbent” and “adsorber” include, respectively, an absorbent and an absorber, and relates, but is not limited to, adsorption, and/or absorption.

As used herein, the term “heat” can mean the isothermal heat of adsorption, which is the total heat involved in the adsorption process from the initial adsorbate loading to the final adsorbate loading at a constant temperature.

### BRIEF DESCRIPTION OF THE DRAWINGS

FIG. 1 is a schematic depiction of an exemplary adsorber and surrounding lines.

FIG. 2 is a perspective view of another exemplary adsorber.

FIG. 3 is a side, elevational view of the another exemplary adsorber of FIG. 2.

FIG. 4 is a cross-sectional view along line 4-4 of the another exemplary adsorber of FIG. 3.

FIG. 5 is a side, elevational, and schematic view of an exemplary exchanger with a series of tubes depicted in phantom.

FIG. 6 is a cross-sectional view of an exemplary tube.

### DETAILED DESCRIPTION

Generally, the embodiments disclosed herein can provide simultaneous adsorption and desorption where internal walls prevent mass transfer between the adsorption and desorption volumes while allowing heat transfer. Once the adsorption zone is saturated, external valving can switch the adsorption and desorption zones. The exchanger can operate nearly isothermally because the heat from adsorption may substantially match the heat removed by desorption. Typically, the adsorbing and desorbing occurs simultaneously in the adsorber by passing the feed and purge streams co-currently through first and second adjacent channels. Generally, this adiabatic process is different from temperature swing adsorption in that the adsorption heat is automatically removed to the desorption side. Because the adsorbent and exchanger internals are not undergoing a temperature swing, the system can have a much higher energy efficiency than temperature controlled adsorption.

A feed stream can have a compound adsorbed by and a purge stream may receive the desorbed compound from the adsorbent. Typically, the feed stream and the purge stream may be, independently, in a liquid or a gas phase. Preferably, the feed stream and the purge stream are in a gas phase for a pressure swing adsorption process.

In one exemplary embodiment, an exchanger can be coated with a suitable adsorbent on both sides of the internals, parting sheets in the case of a plate heat exchanger or tubes in the case of a shell and tube heat exchanger. Because the adsorption and desorption are occurring at almost the same temperature, or desorbing at a slightly lower temperature, the driving force can be affected by the pressure swing and the partial pressure of the adsorbed component. Either by reducing the total pressure during desorption or by using a relatively small amount of desorbing or purge gas relative to that needed for desorbing a bed without heat transfer can aid the driving force. The number of valves of the embodiments herein compared to a temperature controlled adsorption process can be greatly reduced due to eliminating external heating sources by using only a desorbing gas, which can be recycled with a vacuum pump or compressor.

Moreover, the system has a better retrofit potential for ethanol drying, as it can replace the existing pressure swing adsorption dryers with a much smaller amount of adsorbent and there is no concern about thermal fatigue of the adsorbent bonding to the metal internals. By alternating layers of adsorption and desorption, wave channels can move through the adsorbent. This flow from adsorbing layer to desorbing layer can be perpendicular to the heat exchanger sheets. Optionally, a small amount of purge gas can be used to decrease the water partial pressure and increase total pressure volume.

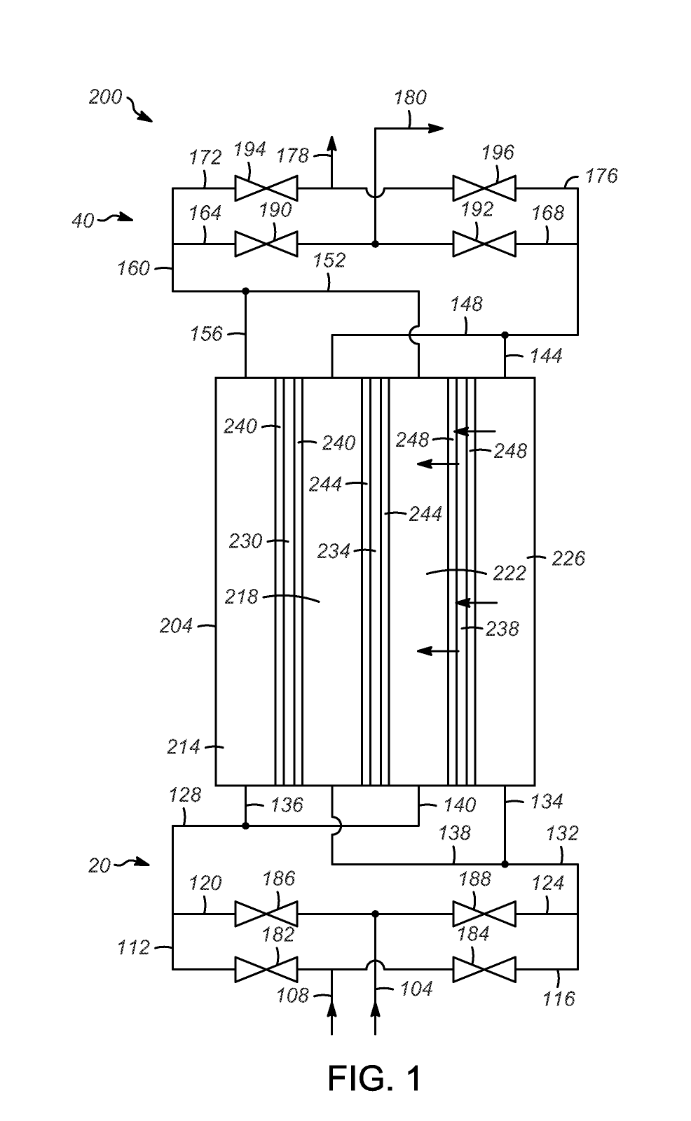

Referring to FIG. 1, an exemplary adsorber apparatus 200 can include a first manifold 20, a second manifold 40, and an adsorber 204. The adsorber 204 can include a plurality of physical barriers or parting sheets and a plurality of adsorbents. The plurality of parting sheets can include a first parting sheet 230, a second parting sheet 234, and a third parting sheet 238. Generally, the plurality of adsorbents can include a first adsorbent 240, a second adsorbent 244, and a third adsorbent 248 with each adsorbent 240, 244, and 248 positioned on either side of respective parting sheets 230, 234, and 238. Preferably, these adsorbents 240, 244, and 248 are the same. The walls of the adsorber 204 and the plurality of parting sheets and adsorbents can form a plurality of channels, namely a first channel 214, a second channel 218, a third channel 222, and a fourth channel 226.

The first manifold 20 can include a series of lines and valves for regulating fluid flow, typically a gas, through the adsorber 204. The first manifold 20 can include lines 104, 108, 112, 116, 120, 124, 128, 132, 134, 136, 138, and 140 and valves 182, 184, 186, and 188. The second manifold 40 can include lines 144, 148, 152, 156, 160, 164, 168, 172, 176, 178, and 180 and valves 190, 192, 194 and 196. Generally, the gas has a component that is adsorbed while a desorbing stream or purge stream, such as an inert gas, e.g., nitrogen, may flow through the adsorber 204 concurrently. In this exemplary embodiment, a feed can be provided in the line 104 and passed through the valve 188 with the valve 186 closed, and the lines 124, 132, 134, and 138. The feed can next pass through the channels 218 and 226. The passage through the fourth channel 226 will be discussed in further detail hereinafter. The third parting sheet 238 can act as a barrier between the channels 222 and 226. A component can be adsorbed from the feed into the third adsorbent 248. Concurrently, a purge stream can be passed through the line 108 and the valve 182 with the valves 184 and 186 closed. The purge stream may pass through the lines 112, 128, 136, and 140 into the channels 214 and 222 with the third channel 222 being discussed in further detail hereinafter. In particular, the arrows depicted in FIG. 1 may indicate the heat generated from the adsorption passing from the fourth channel 226 into the third channel 222 requiring heat for desorption. Any suitable control mechanism for the feed and purge stream flows can maintain the wave of adsorption and desorption through these channels so that the heat transfer may pass from one channel to the next.

As such, the adsorbing and desorbing can occur simultaneously in the adsorber 204. With the channels 222 and 226 being in thermal communication, heat can be transferred from one channel 226 to the other channel 222. Similarly, the first channel 214 can be in thermal communication with the second channel 218 for transferring heat from the second channel 218 to the first channel 214, which can undergo desorption. Generally, the feed streams and purge streams are provided so the fluid flows from the first manifold 20 to the second manifold 40 substantially co-currently. Thus, the heat of adsorption is transferred to the proximate location in the adjacent channel undergoing desorption. Particularly, as the feed travels toward the second manifold 40 in the channel 226, the purge stream travels at the same pace in the third channel 222. So, the adsorption and desorption fluids proceed co-currently and adjacently through the channels 226 and 222. Appropriate temperature controllers can ensure the feed and purge streams are regulated to match the adsorption and desorption profiles.

After adsorption, the effluent from the fourth channel 226 can pass through the lines 144 and 176 through the valve 196 with the valves 192 and 194 being closed. Afterwards, the effluent can exit via the line 178. The purge stream can exit the third channel 222 and exit through the lines 152, 160, and 164 through the valve 190. Afterwards, the desorber fluid can then exit the adsorbing apparatus 200 via the line 180. Thus, the adsorber 204 can operate in a diabatic pressure swing adsorption with the heat of adsorption transferred to an adjacent channel to help the endothermic desorption step.

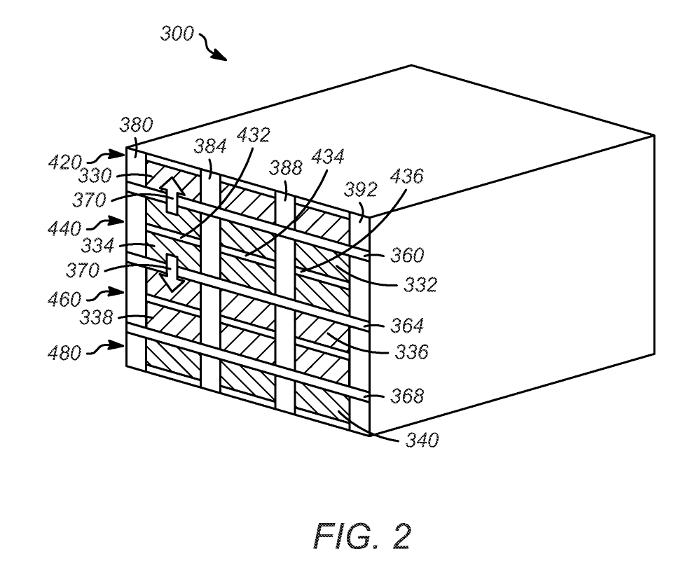

Referring to FIGS. 2-4, an exemplary adsorber 300, which can be a plate-type adsorber, is depicted. Not all the numerals are depicted in FIGS. 2-4 as to not unduly clutter the drawings. In this exemplary embodiment, the adsorber 300 can have a prism shape, similarly as those disclosed in, e.g., US 2010/0132548 A1. The adsorber 300 can include columns of conduits, such as a first conduit 380, a second conduit 384, a third conduit 388, and a fourth conduit 392 at least partially segregated or divided by physical barriers, such as parting sheets 360, 364, and 368. These conduits 380, 384, 388, and 392 can comprise repeating pairs of vertically-stacked adsorbing and desorbing sub-conduits separated by respective parting sheets 360, 364, and 368. Rows of a first adsorbent 330 and a second adsorbent 332 can be positioned on either side of the parting sheet 360, rows of a third adsorbent 334 and a fourth adsorbent 336 can be positioned on either side of the parting sheet 364, and rows of a fifth adsorbent 338 and a sixth adsorbent 340 can be positioned on either side of the parting sheet 368.

The walls of the adsorber 300 and the adsorbents 330, 332, 334, 336, 338, and 340 can form channels at different elevations, and include a plurality of channels 420 at a first elevation 350, another plurality of channels 440 at a second elevation 352, yet a further plurality of channels 460 at a third elevation 354, and a still further plurality of channels 480 at a fourth elevation 356.

Typically, the physical barrier can be a metal plate and/or other material to prevent mass transfer and segregate channels at different elevations. This plurality of channels 420, 440, 460, and 480 can be similar, so only the plurality of channels 440 is discussed in further detail hereinafter.

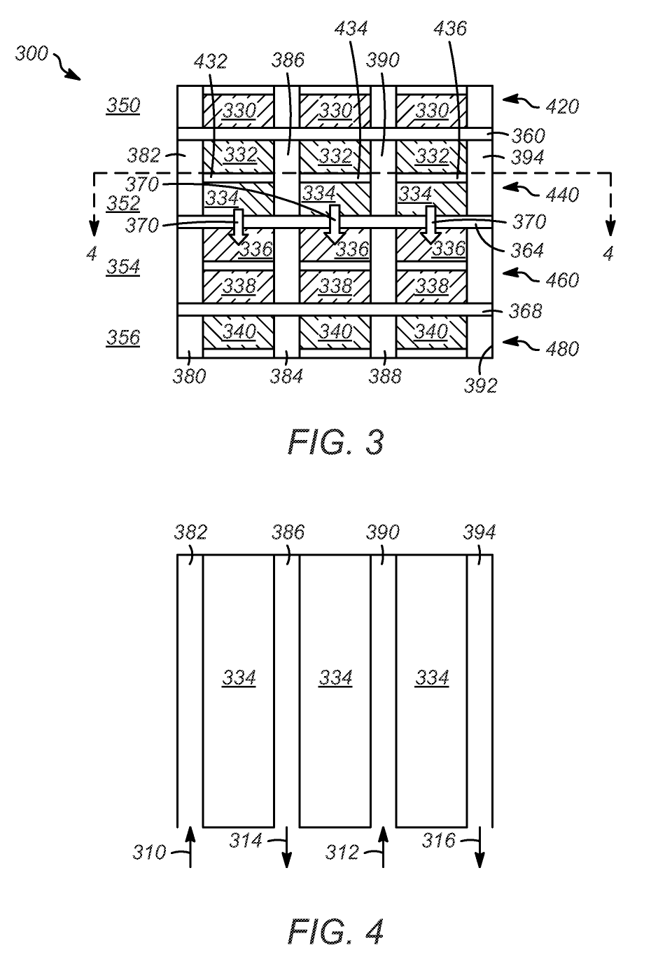

As depicted in FIGS. 3-4, the plurality of channels 440 can include a first channel 432, a second channel 434, and a third channel 436. The channels 432, 434, and 436 can be at least partially bordered by an adsorbent, such as respectively, adsorbents 332 and 334. Moreover, conduits 382, 386, 390, and 394 are sub-conduits to the conduits 380, 384, 388, and 392 at the second elevation 352.

Typically, the feed 310 and 312 includes an adsorbable component for removal and can pass through respective conduits 382 and 390 at the second elevation 352. Any suitable header or manifold can provide a feed or purge stream to a respective channel. Generally, the adsorber 300 has alternate rows of adsorbent being adsorbed and desorbed. In this particular example, desorbents 332, 334, and 340 can be adsorbing while adsorbents 330, 336, and 338 can be desorbing. Utilizing suitable controls and manifolds, the adsorbents 330, 332, 334, 336, 338, and 340 can be switched from adsorption to desorption, and vice-versa. Only the adsorbent 334 is being described hereinafter, as the adsorbents 332 and 340 operate in a similar manner.

The feed 310 can fill the conduit 382 and pass over the adsorbent 334 toward the conduit 386 forming a substantially uniform profile along the length of the adsorbent 334. Similarly, the feed 312 can fill the conduit 390, form substantially similar profiles along the length of the adsorbent 334, and pass toward the conduits 386 and 394. As the feed 310 and 312 passes over the adsorbent 334, a heat adsorption wave 370 can be created passing downward to the adsorbent 336, which can be desorbed co-currently with the adsorbent 334 being adsorbed above. Typically, a purge stream can desorb the adsorbents 336 and 338 through the yet another plurality of channels 460, forming similar desorption profiles on the adsorbent 336. The desorption in the channels 460 can be conducted simultaneously with the adsorption in the channels 440 so heat can be transferred from adsorption to desorption. Afterwards, the feed 314 and 316 having an adsorbable component removed can exit conduits 386 and 394. Next, the adsorbent can be similarly desorbed by providing a purge stream in conduits 382 and 390 that can exit conduits 386 and 394.

The heat adsorption wave 370 can provide the heat to the adsorbent 336 undergoing desorption. Thus, the heat generated by adsorption in adsorbent 334 can be used to provide the heat for the desorption proceeding to the channels 460. Thus, such a design can eliminate the need for additional streams removing heat for adsorbing and providing heat for desorbing.

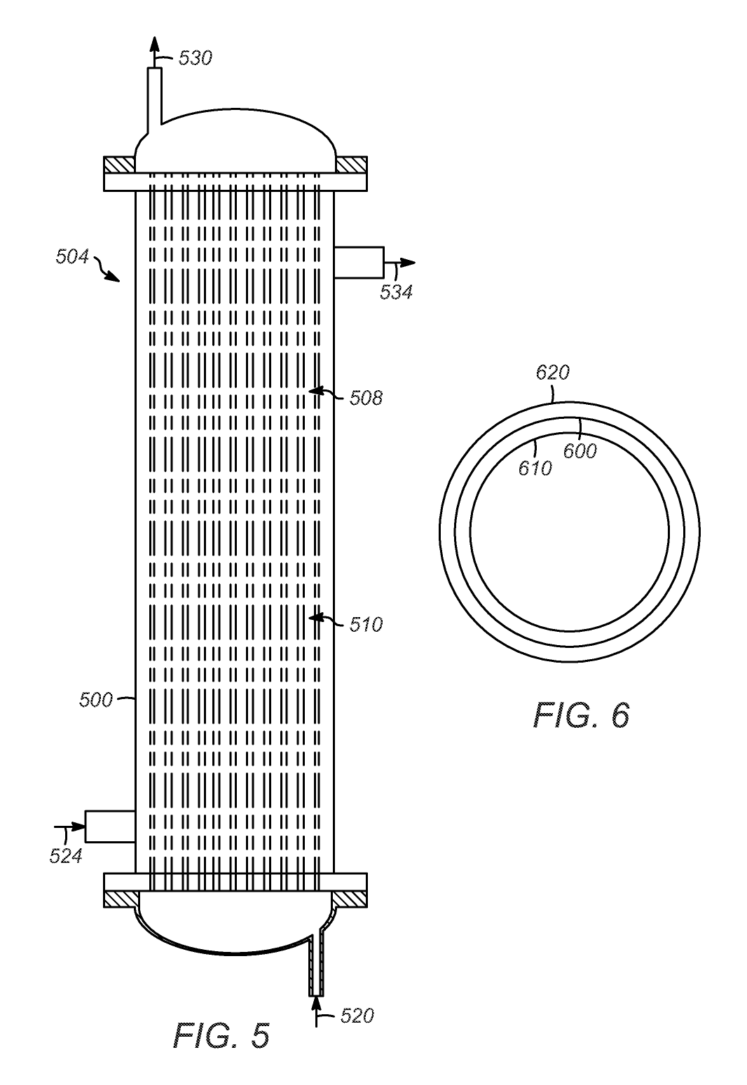

However, the embodiments disclosed herein can be used in other suitable adsorbers. Referring to FIGS. 5-6, an exemplary exchanger 500 can include a shell 504 and one or more tubes 508. Generally, the exchanger 500 can be oriented vertically 510, alternatively horizontally in other embodiments with one or more tubes 508 receiving the feed and purge streams operating in a gas phase. The exchanger 500 can include a tube inlet 520 and a tube outlet 530. Also, the exchanger can include a shell inlet 524 and a shell outlet 534. As depicted in FIG. 6, one exemplary tube 600 can have an inner adsorbent layer 610 and an outer adsorbent layer 620. The tube 600 can be fashioned from any suitable material, such as metal, to prevent the mass transfer of material across the barrier.

In operation, a feed can be provided to the tube inlet 520 and pass through one or more of the series of tubes 508. A component in the feed can be adsorbed into the inner adsorbent layer 610. Simultaneously, a purge stream can be passed through the shell inlet 524. The flow passing through the tube inlet 520 and the shell inlet 524 can be coordinated so that material in the outer adsorbent layer 620 can be desorbed while simultaneously, material is being adsorbed inside the tube 600. The flows of the feed and purge streams can be controlled to allow the heat of adsorption pass to the desorption occurring outside of the one or more tubes 508. In one example, the adsorption-desorption waves can proceed substantially simultaneously up the one or more tubes 508. Heat can pass from the adsorption process inside the tube 600 to the desorption process on the outside of the tube 600. The effluent from the one or more tubes 508 can pass through the tube outlet 530 while effluent from the shell can pass through the shell outlet 534. After an adsorption cycle has been completed, the flow can be reversed so that the outer adsorbent layer 620 can adsorb material while the inner adsorbent layer 610 can be desorbed. In such a manner, flow can then be controlled to allow co-current processing.

In the embodiments discussed herein, any suitable adsorbent, physical barrier, feed stream, and purge stream may be utilized. The adsorptive material can be any suitable material containing a polymer or a zeolite, such as, e.g., a Type 4A or a Type 3A zeolite. Other adsorptive materials can include a molecular sieve including a Type A and X, NaY, silica gel, and/or alumina. Other exemplary zeolites that may be used are disclosed in, e.g., US 2008/0314244 A1. These materials may be used in any suitable thickness, such as about 0.0001-about 0.0013 meter, preferably from about 0.0035-about 0.0058 meter. Adsorbent materials can take the form of spherical beads or pellets. The physical barrier material can be any suitable material, such as aluminized mylar, a polymer composite, a metal, such as aluminum, copper, titanium, brass, and/or stainless steel, or a graphite fiber composite materials.

Suitable process streams can include separating water from alcohols, primarily ethanol although other possible streams can be utilized. The purge stream can be any suitable stream, typically an inert material such as nitrogen. Alternatively, a feed can have a different component that is recovered by adsorption. Other components can include mercury, one or more volatile organic compounds, water, carbon dioxide, nitrous oxide, one or more halocarbon refrigerants, and propylene. Such suitable components are disclosed in, e.g., US 2010/0150812 A1. Generally, the adsorbing and desorbing can occur at a temperature of about 70-about 110° C. and a pressure of about 30-about 175 kPa.

In one exemplary system, a feed including water and ethanol can be passed through the adsorber. Co-currently, a purge stream of nitrogen can be passed so the heat of adsorption from adsorbing water from the ethanol in the adsorbent can pass into the desorbing channel where nitrogen removes the water from the adsorbent. Alternatively, desorbing gas can be a portion of the product gas that is sent back for desorbing gas.

In adsorbers disclosed herein, at least about 50%, preferably at least about 70%, and optimally at least about 90%, of the heat, which can be measured by any suitable unit such as Joules, generated by adsorption can be transferred, typically from adsorption to desorption. It should be understood that the embodiments disclosed herein may be utilized if heat is required for adsorption and generated during desorption.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process for pressure swing adsorption, comprising:
passing a fluid through a first channel for adsorbing at least one component while simultaneously passing a stream desorbing a component through a second channel wherein the first and second channels are in thermal communication for transferring heat from the first channel undergoing adsorption to the second channel undergoing desorption.

2. The process according to claim 1, further comprising providing an adsorber forming the first channel and the second channel.

3. The process according to claim 2, wherein adsorbing and desorbing occurs simultaneously in the adsorber.

4. The process according to claim 1, wherein the fluid and the desorbing stream pass through the first and second channels substantially co-currently.

5. The process according to claim 3, wherein an adsorber forms a plurality of channels arranged at different elevations.

6. The process according to claim 4, wherein at least about 50% of the heat generated by adsorption is transferred to desorption.

7. The process according to claim 4, wherein at least about 70% of the heat generated by adsorption is transferred to desorption.

8. The process according to claim 4, wherein at least about 90% of the heat generated by adsorption is transferred to desorption.

9. The process according to claim 5, further comprising providing a physical barrier in the adsorber to segregate rows of channels at a first elevation from adjacent rows of channels at a second elevation.

10. The process according to claim 1, wherein the fluid comprises water and ethanol.

11. The process according to claim 10, wherein water is adsorbed from the fluid.

12. The process according to claim 11, wherein water is desorbed from an adsorbent.

13. The process according to claim 12, wherein the adsorbent comprises a molecular sieve.

14. The process according to claim 13, wherein the molecular sieve comprises a zeolite.

15. The process according to claim 10, wherein the fluid is at a temperature of about 70-about 110° C. and a pressure of about 30-about 175 kPa.

16. A process for pressure swing adsorption, comprising:
A) providing an adsorber forming a first channel and a second channel;
B) providing a feed to the first channel wherein a component of the feed is adsorbed; and
C) providing simultaneously a co-current purge stream to the second channel wherein the component is desorbed; wherein heat generated is communicated between the first and second channels.

17. The process according to claim 16, wherein at least about 50% of the heat generated by adsorption is transferred to desorption.

18. A process for pressure swing adsorption, comprising:
A) an adsorber forming a plurality of channels at a first elevation and another plurality of channels at a second elevation;
B) passing a feed into the plurality of channels at the first elevation wherein a component of the feed is adsorbed; and
C) passing a purge stream into the another plurality of channels at the second elevation wherein the component is desorbed, wherein heat generated from adsorption is communicated to the another plurality of channels undergoing desorption.

19. The process according to claim 18, wherein at least about 50% of the heat generated by adsorption is transferred to desorption.

20. The process according to claim 18, wherein the feed and the purge stream pass through the first and second channels co-currently.
